(19) United States
(12) Patent Application Publication
(10) Pub. No.: US 2024/0332589 A1
(43) Pub. Date: Oct. 3, 2024

(54) METHOD FOR MANUFACTURING SOLID-STATE SECONDARY BATTERY

(71) Applicant: HONDA MOTOR CO., LTD., Tokyo (JP)

(72) Inventors: Takashi NAKAGAWA, Saitama (JP); Yohei NOJI, Saitama (JP); Kyohei IZUMI, Saitama (JP); Hiroki ICHIHARA, Saitama (JP); Hayato TAKAHASHI, Saitama (JP); Katsutoshi SAKURAI, Saitama (JP); Fumika FUJISAKI, Saitama (JP)

(21) Appl. No.: 18/607,565

(22) Filed: Mar. 18, 2024

(30) Foreign Application Priority Data
Mar. 31, 2023 (JP) 2023-059660

(51) Int. Cl. H01M 10/04

(52) U.S. Cl. CPC H01M 10/04

(57) ABSTRACT

The invention provides a method for manufacturing a solid-state secondary battery including a multilayer electrode structure including a negative electrode layer, an intermediate layer, a solid electrolyte layer, and a positive electrode layer stacked in order. The method includes a step 1A including pressure-bonding a negative electrode layer and an intermediate layer to form a stack of the negative electrode layer and the intermediate layer; a step 1B including pressure-bonding the intermediate layer of the stack and a solid electrolyte layer to form a stack of the negative electrode layer, the intermediate layer, and the solid electrolyte layer; and a step 1C including pressure-bonding the solid electrolyte layer of the stack and a positive electrode layer to form the multilayer electrode structure.

This application is based on and claims the benefit of priority from Japanese Patent Application No. 2023-059660, filed on 31 Mar. 2023, the content of which is incorporated herein by reference.

### BACKGROUND OF THE INVENTION

### Field of the Invention

The present invention relates to a method for manufacturing a solid-state secondary battery.

### Related Art

In recent years, secondary batteries that contribute to energy efficiency have been researched and developed to ensure that more people have access to affordable, reliable, sustainable, and advanced energy. Among secondary batteries, solid-state secondary batteries have attracted particular attention since they are advantageous in that they use non-flammable solid electrolytes, which improve their safety, and have higher energy density.

To provide solid-state secondary batteries with improved energy density, studies have been conducted on solid-state secondary batteries with a multilayer structure including multiple positive and negative electrode layers alternately stacked on each other. In general, solid-state secondary batteries with such a multilayer structure are manufactured by pressure-bonding positive electrode layers, solid electrolyte layers, and negative electrode layers (see Patent Document 1).
Patent Document 1: Japanese Patent No. 6790919

### SUMMARY OF THE INVENTION

Meanwhile, the cycle characteristics of solid-state secondary batteries remain to be improved. To improve the cycle characteristics of solid-state secondary batteries, studies have been conducted on a multilayer structure having an intermediate layer between a negative or positive electrode layer and a solid electrolyte layer. Unfortunately, in some cases, such an intermediate layer causes the solid electrolyte layer to undergo non-uniform stress during pressure-bonding so that the resulting battery may have an internal short circuit due to breaking, cracking, or any other defect in the solid electrolyte layer. The inventors' study has revealed that an intermediate layer provided between a negative electrode layer and a solid electrolyte layer and having a Young's modulus smaller than that of the solid electrolyte layer particularly tends to cause the solid electrolyte layer to suffer from defects during pressure-bonding.

It is an object of the present invention, which has been made in view of the circumstances described above, to provide a manufacturing method that can produce a solid-state secondary battery with its solid electrolyte layer being less likely to suffer from defects even in a multilayer structure having an intermediate layer between the solid electrolyte layer and a negative electrode layer. It is another object of the present invention to provide a solid-state secondary battery manufacturing method that contributes to energy efficiency.

The inventors have created a solid-state secondary battery manufacturing process including: first pressure-bonding a negative electrode layer and an intermediate layer to form a stack of the intermediate layer and the negative electrode layer; then pressure-bonding the intermediate layer of the stack and a solid electrolyte layer at a bonding pressure lower than that for the bonding of the negative electrode layer and the intermediate layer; and then pressure-bonding the solid electrolyte layer and a positive electrode layer at a bonding pressure higher than that for the bonding of the negative electrode layer and the intermediate layer or a solid-state secondary battery manufacturing process including: first pressure-bonding a negative electrode layer and an intermediate layer to form a stack of the intermediate layer and the negative electrode layer; and then pressure-bonding the intermediate layer of the stack, a solid electrolyte layer, and a positive electrode layer at a bonding pressure higher than that for the bonding of the negative electrode layer and the intermediate layer. The inventors have completed the present invention based on findings that such a process can provide a solution to the problem described above. Thus, the present invention provides the solid-state secondary battery manufacturing method defined below.

(1) A method for manufacturing a solid-state secondary battery including a multilayer electrode structure including a negative electrode layer, an intermediate layer, a solid electrolyte layer, and a positive electrode layer stacked in order, the method including: a step 1A including pressure-bonding a negative electrode layer and an intermediate layer to form a stack of the negative electrode layer and the intermediate layer; a step 1B including pressure-bonding the intermediate layer of the stack and a solid electrolyte layer to form a stack of the negative electrode layer, the intermediate layer, and the solid electrolyte layer; and a step 1C including pressure-bonding the solid electrolyte layer of the stack and a positive electrode layer to form the multilayer electrode structure, wherein the pressure-bonding in the step 1B is performed at a bonding pressure lower than that for the pressure-bonding in the step 1A, and wherein the pressure-bonding in the step 1C is performed at a bonding pressure higher than that for the pressure-bonding in the step 1A.

In the method (1) for manufacturing a solid-state secondary battery, the step 1A includes pressure-bonding a negative electrode layer and an intermediate layer to form a stack of the negative electrode layer and the intermediate layer, the step 1B includes pressure-bonding the intermediate layer of the stack and a solid electrolyte layer to form a stack of the negative electrode layer, the intermediate layer, and the solid electrolyte layer, and the step 1C includes pressure-bonding the solid electrolyte layer of the stack and a positive electrode layer to form the multilayer electrode structure. The bonding pressure in the step 1B is lower than that in the step 1A. In the step 1B, therefore, the solid electrolyte layer is less likely to suffer from defects, such as breaking and cracking. Moreover, in the step 1C, the solid electrolyte layer is supported by the intermediate layer and the negative electrode layer. In the step 1C, therefore, the solid electrolyte layer is less likely to suffer from defects even during the pressure-bonding at a bonding pressure higher than that for the pressure-bonding in the step 1A. In the method (1) for manufacturing a solid-state secondary battery, therefore, the solid electrolyte layer is less likely to suffer from defects even in the structure having the intermediate layer between the negative electrode layer and the solid electrolyte layer.

(2) The method according to aspect (1), further including, after the step 1C, a step 1D including applying a pressure to the multilayer electrode structure in a direction in which the layers are stacked, wherein the pressure is higher than the bonding pressure for the pressure-bonding in the step 1C.

In the step 1D of the method (2) for manufacturing a solid-state secondary battery, a pressure higher than that for the pressure-bonding in the step 1C is applied to the multilayer electrode structure in a direction in which the layers are stacked. Such pressure application densifies the multilayer electrode structure and increases the bonding strength between the layers in the multilayer electrode structure. Thus, the resulting solid-state secondary battery has reduced internal resistance and improved characteristics, such as improved cycle characteristics.

(3) The method according to aspect (1) or (2), wherein the negative electrode layer, the intermediate layer, the solid electrolyte layer, and the positive electrode layer have Young's moduli in the order: the Young's modulus of the intermediate layer<the Young's modulus of the negative electrode layer<the Young's modulus of the solid electrolyte layer<the Young's modulus of the positive electrode layer.

In the method (3) for manufacturing a solid-state secondary battery, the solid electrolyte layer is less likely to suffer from defects even with the Young's modulus of the intermediate layer being lower than that of each of the positive electrode layer, the solid electrolyte layer, and the negative electrode layer.

(4) The method according to any one of aspects (1) to (3), wherein the pressure-bonding in the step 1A is performed at a bonding pressure in the range of 300 to 500 MPa, wherein the pressure-bonding in the step 1B is performed at a bonding pressure in the range of 50 to 100 MPa, and wherein the pressure-bonding in the step 1C is performed at a bonding pressure of 800 MPa or less.

In the method (4) for manufacturing a solid-state secondary battery, the solid electrolyte layer is further less likely to suffer from defects because of the bonding pressures in the steps 1A, 1B, and 1C falling within the specified ranges.

(5) The method according to any one of aspects (1) to (4), wherein the intermediate layer has a porosity greater than that of the solid electrolyte layer.

In the method (5) for manufacturing a solid-state secondary battery, the intermediate layer with a porosity greater than that of the solid electrolyte layer can prevent uneven deposition of metal on the negative electrode layer interface, which allows the production of a solid-state secondary battery with improved cycle characteristics.

(6) The method according to aspect (2), wherein the pressure-bonding in the steps 1C and 1D is performed using a roll press machine, wherein the step 1C includes feeding the stack of the negative electrode layer, the intermediate layer, and the solid electrolyte layer in a first direction to the roll press machine, wherein the step 1D includes feeding the multilayer electrode structure in a second direction to the roll press machine, and wherein the first direction differs from the second direction.

In the method (6) for manufacturing a solid-state secondary battery, in which the feed direction of the stack of the negative electrode layer, the intermediate layer, and the solid electrolyte layer in the step 1C differs from that of the multilayer electrode structure in the step 1D, the solid electrolyte layer is less likely to suffer from defects than when the steps 1C and 1D are performed by a roll-to-roll process in which the low Young's modulus layer, such as the negative electrode layer or the intermediate layer, is stretched only in a single direction so that the solid electrolyte layer can also be stretched.

(7) A method for manufacturing a solid-state secondary battery including a multilayer electrode structure including a negative electrode layer, an intermediate layer, a solid electrolyte layer, and a positive electrode layer stacked in order, the method including: a step 2A including pressure-bonding a negative electrode layer and an intermediate layer to form a stack of the negative electrode layer and the intermediate layer; and a step 2B including placing a solid electrolyte layer and a positive electrode layer in order on the intermediate layer of the stack and pressure-bonding the intermediate layer of the stack, the solid electrolyte layer, and the positive electrode layer to form the multilayer electrode structure, wherein the pressure-bonding in the step 2B is performed at a bonding pressure higher than that for the pressure-bonding in the step 2A.

In the method (7) for manufacturing a solid-state secondary battery, the step 2A includes pressure-bonding a negative electrode layer and an intermediate layer to form a stack of the intermediate layer and the negative electrode layer, and the step 2B includes placing a solid electrolyte layer and a positive electrode layer in order on the intermediate layer of the stack and pressure-bonding the intermediate layer of the stack, the solid electrolyte layer, and the positive electrode layer to form the multilayer electrode structure. In the step 2B, the solid electrolyte layer is less likely to suffer from defects even during the pressure-bonding at a bonding pressure higher than that for the pressure-bonding in the step 2A because it is supported between the positive electrode layer and the stack of the intermediate layer and the negative electrode layer. In the method (7) for manufacturing a solid-state secondary battery, therefore, the solid electrolyte layer is less likely to suffer from defects even in the structure having the intermediate layer between the negative electrode layer and the solid electrolyte layer.

(8) The method according to aspect (7), wherein the intermediate layer includes an inner porous substrate.

In the method (8) for manufacturing a solid-state secondary battery, the solid electrolyte layer is less likely to deform during the pressure-bonding in the step 2B because it includes an inner porous substrate. This means that the solid electrolyte layer is less likely to suffer from defects.

(9) The method according to aspect (7) or (8), further including, after the step 2B, a step 2C including applying a pressure to the multilayer electrode structure in a direction in which the layers are stacked, wherein the pressure is higher than the bonding pressure for the pressure-bonding in the step 2B.

In the step 2C of the method (9) for manufacturing a solid-state secondary battery, a pressure higher than that for the pressure-bonding in the step 2B is applied to the multilayer electrode structure in a direction in which the layers are stacked. Such pressure application densifies the multilayer electrode structure and increases the bonding strength between the layers in the multilayer electrode structure. Thus, the resulting solid-state secondary battery has reduced internal resistance and improved characteristics, such as improved cycle characteristics.

(10) The method according to any one of aspects (7) to (9), wherein the negative electrode layer, the intermediate layer, the solid electrolyte layer, and the positive electrode layer have Young's moduli in the order: the Young's modulus of the intermediate layer<the Young's modulus of the negative electrode layer<the Young's modulus of the solid electrolyte layer<the Young's modulus of the positive electrode layer.

In the method (10) for manufacturing a solid-state secondary battery, the solid electrolyte layer is less likely to suffer from defects even with the Young's modulus of the intermediate layer being lower than that of each of the positive electrode layer, the solid electrolyte layer, and the negative electrode layer.

(11) The method according to any one of aspects (7) to (10), wherein the pressure-bonding in the step 2A is performed at a bonding pressure in the range of 300 to 500 MPa, and wherein the pressure-bonding in the step 2B is performed at a bonding pressure of 800 MPa or less.

In the method (11) for manufacturing a solid-state secondary battery, the solid electrolyte layer is further less likely to suffer from defects because of the bonding pressures in the steps 2A and 2B falling within the specified ranges.

(12) The method according to any one of aspects (7) to (11), wherein the intermediate layer has a porosity greater than that of the solid electrolyte layer.

In the method (12) for manufacturing a solid-state secondary battery, the intermediate layer with a porosity greater than that of the solid electrolyte layer can prevent uneven deposition of metal on the negative electrode layer interface, which allows the production of a solid-state secondary battery with improved cycle characteristics.

(13) The method according to aspect (9), wherein the pressure-bonding in the steps 2B and 2C is performed using a roll press machine, wherein the step 2B includes feeding the stack of the intermediate layer and the negative electrode layer in a first direction to the roll press machine, wherein the step 2C includes feeding the multilayer electrode structure in a second direction to the roll press machine, and wherein the first direction differs from the second direction.

In the method (13) for manufacturing a solid-state secondary battery, in which the feed direction of the stack of the intermediate layer and the negative electrode layer in the step 2B differs from that of the multilayer electrode structure in the step 2C, the solid electrolyte layer is less likely to suffer from defects than when the step 2B and 2C are performed by a roll-to-roll process in which the low Young's modulus layer, such as the negative electrode layer or the intermediate layer, is stretched only in a single direction so that the solid electrolyte layer can also be stretched.

The present invention provides a manufacturing method that can produce a solid-state secondary battery with its solid electrolyte layer being less likely to suffer from defects even in a multilayer structure having an intermediate layer between the solid electrolyte layer and a negative electrode layer.

### BRIEF DESCRIPTION OF THE DRAWINGS

FIG. 1 is a cross-sectional view of an example of a solid-state secondary battery that can be manufactured by a solid-state secondary battery manufacturing method according to the present invention;

FIG. 2 is a flow chart showing a solid-state secondary battery manufacturing method according to a first embodiment of the present invention; and

FIG. 3 is a flow chart showing a solid-state secondary battery manufacturing method according to a second embodiment of the present invention.

### DETAILED DESCRIPTION OF THE INVENTION

Hereinafter, embodiments of the present invention will be described with reference to the drawings. It should be noted that the embodiments described below are only by way of example and are not intended to limit the present invention.

### <Solid-State Secondary Battery>

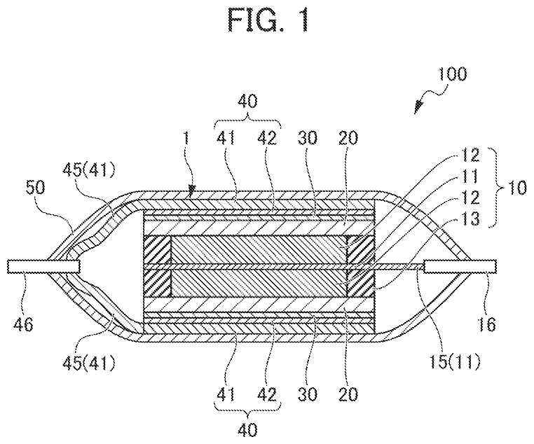

The method of the present invention is useful to manufacture solid-state secondary batteries, which will be described below. FIG. 1 is a cross-sectional view of an example of a solid-state secondary battery that can be manufactured by the solid-state secondary battery manufacturing method of the present invention.

As shown in FIG. 1, the solid-state secondary battery 100 includes a multilayer electrode structure 1 and an outer case 50 that houses the multilayer electrode structure 1. The multilayer electrode structure 1 includes a positive electrode layer 10, a solid electrolyte layer 20, an intermediate layer 30, and a negative electrode layer 40 stacked in order. The positive electrode layer 10 includes a positive electrode current collector 11 and positive electrode active material layers 12 provided on both sides of the positive electrode current collector 11. The positive electrode active material layers 12 each have an outer circumference surrounded by an insulating frame 13. The positive electrode current collector 11 is connected to a positive electrode terminal 16 via a positive electrode lead wire 15. An intermediate layer 30 and a negative electrode layer 40 are stacked on each of the positive electrode active material layers 12 provided on both sides of the positive electrode current collector 11. The negative electrode layer 40 includes a negative electrode current collector 41 and a metal layer 42 provided on the solid electrolyte layer 20-side surface of the negative electrode current collector 41. The negative electrode current collector 41 is connected to a negative electrode terminal 46 via a negative electrode lead wire 45. The positive electrode terminal 16 and the negative electrode terminal 46 are partially exposed from the outer case 50. The multilayer electrode structure 1 shown in FIG. 1 is in a discharged state. When the negative electrode layer 40 is in a charged state, metal ions, which are charge carriers, deposit on the surface of the metal layer 42 to form a metal deposit layer. The metal deposit layer acts as a negative electrode active material layer and releases metal ions during discharging.

The positive electrode current collector 11 may be made of any material with any shape as long as it functions to collect electricity in the positive electrode layer 10. The positive electrode current collector 11 may be made of, for example, aluminum, an aluminum alloy, stainless steel, nickel, iron, or titanium, among which aluminum, an aluminum alloy, or stainless steel is preferred. The positive electrode current collector 11 is, for example, in a foil shape, a sheet or plate shape, or any other suitable shape.

The positive electrode active material layer 12 includes at least one positive electrode active material. The positive electrode active material may be any suitable type, such as that used for positive electrode layers for common solid-state secondary batteries. The positive electrode active material may be, for example, a lithium-containing layered active material, a spinel-type active material, or an olivine-type active material. Examples of the positive electrode active material include lithium cobaltate (LiCoO₂), lithium nickelate (LiNiO₂), LiNiₚMn_{q}CoᵣO₂ (p+q+r=1), LiNiₚAl_{q}CoᵣO₂ (p+q+r=1), lithium manganate (LiMn₂O₄), hetero-element-substituted Li—Mn spinel oxides represented by Li₁₊ₓMn_{2-x-y}MO₄ (x+y=2, M=at least one selected from Al, Mg, Co, Fe, Ni, or Zn), lithium titanate (oxides containing Li and Ti), and lithium metal phosphate (LiMPO₄, M=at least one selected from Fe, Mn, Co, or Ni).

The positive electrode active material layer 12 may optionally contain a solid electrolyte for improving the charge carrier conductivity. The positive electrode active material layer 12 may also optionally contain a conducting aid for improving conductivity. The positive electrode active material layer 12 may also optionally contain a binder for imparting flexibility. The solid electrolyte, the conducting aid, and the binder may be any suitable type, such as those used for positive electrode layers for common solid-state secondary batteries.

At 20° C., the insulating frame 13 may have a volume resistivity of 1×10¹² Ω·cm or more or a volume resistivity in the range of 1×10¹² to 1×10¹⁷ Ω·cm or in the range of 1×10¹⁴ to 1×10¹⁷ Ω·cm. The insulating frame 13 has a porosity of 40% or less. Its porosity may be 20% or less or in the range of 1 to 20%. With too high a porosity, the insulating frame 13 may have difficulty in maintaining its structure during high pressurization in the battery manufacturing process and may provide a high risk of short circuit, which is caused by intrusion of physically deposited metal into the insulting frame 13 during charging and discharging.

The insulating frame 13 may be an organic or inorganic material. The insulating frame 13 includes an insulating material, examples of which include rubber, glass, resin (e.g., polyimide, polybenzimidazole, polyamide-imide, polyetherimide, polyacetal, polyphenylene sulfide, polyetheretherketone, tetrafluoroethylene, polyamide 6 (nylon 6), ultra-high molecular weight polyethylene, polyethylene, polypropylene, polyvinyl chloride resin, polystyrene, polyethylene terephthalate, ABS resin), and ceramics (e.g., alumina, zirconia, silicon nitride, aluminum nitride, mullite, steatite, magnesia, sialon, macerite). The insulating frame 13 may include a single insulating material or a composite of two or more insulating materials. The insulating frame 13 may also contain a small amount of a binding material or an additive. The breakdown voltage per unit thickness of the insulating frame 13 is preferably 10 kV/mm or more, more preferably 100 kV/mm or more.

The positive electrode lead wire 15 may be made of the same material as the positive electrode current collector 11 or may be made of a material different from that of the positive electrode current collector 11. The positive electrode lead wire 15 may be integrally connected to the positive electrode current collector 11. In an embodiment, the positive electrode lead wire 15 is formed as an extension of the positive electrode current collector 11 and integrally connected to the positive electrode current collector 11. The positive electrode terminal 16 may be made of the same material as the positive electrode lead wire 15 or may be made of a material different from that of the positive electrode lead wire 15. The positive electrode terminal 16 may be integrally connected to the positive electrode lead wire 15. In an embodiment, the positive electrode terminal 16 and the positive electrode lead wire 15 are different members electrically connected to each other.

The solid electrolyte layer 20 is between the positive electrode layer 10 and the negative electrode layer 40 in the stack. The solid electrolyte layer 20 includes at least one solid electrolyte material. The solid electrolyte layer 20 enables charge carrier conduction between the positive and negative electrode layers 10 and 40 though the solid electrolyte material therein.

The solid electrolyte material may be any type having charge carrier conductivity, such as a sulfide solid electrolyte material, an oxide solid electrolyte material, a nitride solid electrolyte material, or a halide solid electrolyte material.

Examples of the sulfide solid electrolyte material include Li₂S—P₂S₅ and Li₂S—P₂S₅—LiI. The expression “Li₂S—P₂S₅” means a sulfide solid electrolyte material produced using a raw material composition including Li₂S and P₂S₅. The same applies to similar expressions. The sulfide solid electrolyte material may have an argyrodite-type crystal structure.

Examples of the oxide solid electrolyte material include NASICON-type oxides, garnet-type oxides, and perovskite-type oxides. Examples of NASICON-type oxides include oxides including Li, Al, Ti, P, and O (e.g., Li_{1.5}Al_{0.5}Ti_{1.5}(PO₄)₃). Examples of garnet-type oxides include oxides including Li, La, Zr, and O (e.g., Li₇La₃Zr₂O₁₂). Examples of perovskite-type oxides include oxides including Li, La, Ti, and O (e.g., LiLaTiO₃).

The solid electrolyte layer 20 may include a binder. The binder may be any suitable type, such as that used for solid electrolyte layers for common solid-state secondary batteries.

The solid electrolyte layer 20 has a porosity lower than that of the intermediate layer 30 described later, such as a porosity of less than 10%. In the solid electrolyte layer 20, the solid electrolyte material is, for example, in the form of particles with a median diameter (D50) of 0.5 to 10 μm, which is preferably larger than that of the particles in the intermediate layer 30 described later.

The porosity of the solid electrolyte layer 20 can be calculated from, for example, Equation (1) below. In Equation (1), “filling factor” means the percentage of the density of the shaped solid electrolyte layer to the true density.

Porosity (%)=(100−filling factor (%)) (1)

The intermediate layer 30 is between the solid electrolyte layer 20 and the negative electrode layer 40 in the stack. The intermediate layer 30 functions to prevent uneven deposition of metal ions on the interface of the negative electrode layer 40 and to increase the interfacial bonding strength.

The solid electrolyte layer 20 may include an inner porous substrate. The porous substrate may be, for example, a woven or unwoven fabric. The solid electrolyte including an inner porous substrate has high strength.

The intermediate layer 30 preferably has electron conductivity and pores through which metal ions (charge carriers), such as lithium ions, can pass. When the intermediate layer 30 has pores, metal ions can move from the solid electrolyte layer 20 to the negative electrode layer 40 through the intermediate layer 30 and deposit on the intermediate layer 30-side surface of the negative electrode current collector 41 of the negative electrode layer 40 to form a metal deposit layer (metallic lithium layer) during the charging of the solid-state secondary battery 100. Metal ions passing through the intermediate layer 30 can uniformly form a metal deposit layer on the surface of the metal layer 42. The intermediate layer 30 with such pores also has such a degree of flexibility that it can follow changes in the thickness of the negative electrode layer 40 during charging and discharging. Therefore, even during charge-discharge cycles, the solid-state secondary battery 100 can maintain the interfacial bonding and can have improved durability.

The porosity of the intermediate layer 30 is preferably higher than that of the solid electrolyte layer 20. In such a case, the interior of the intermediate layer 30 has a large number of pores, through which metal ions can pass to form a more uniform metal deposit layer on the surface of the metal layer 42. In such a case, the intermediate layer 30 is also more flexible and thus can better follow changes in the thickness of the negative electrode layer 40. The porosity of the intermediate layer 30 may be, for example, 40 to 70%. The porosity of the intermediate layer 30 may be calculated by the same method as for the calculation of the porosity of the solid electrolyte layer 20.

The intermediate layer 30 may have a thickness of 5 μm or less. When the intermediate layer 30 has a thickness of 5 μm or less, metal ions, which serve as charge carriers during charging, can deposit at positions between the intermediate layer 30 and the negative electrode layer 40. In such a case, the frequency of direct contact between the solid electrolyte layer 20 and the metal deposit is significantly low so that the solid electrolyte layer 20 is less likely to undergo local degradation or current concentration and can provide improved cycle characteristics and storage characteristics. In such a case, the intermediate layer 30 disposed between the solid electrolyte layer 20, which is relatively hard, and the metal deposit is also relatively elastic and thus can easily follow expansion and contraction caused by deposition and dissolution of the metal, which allows a homogeneous reaction to proceed in the in-plane and thickness directions and is effective in reducing the resistance and improving the cycle characteristics. To be more effective in reducing the resistance and improving the cycle characteristics, the intermediate layer may have a thickness of 3 μm or less or a thickness in the range of 1 to 3 μm.

The intermediate layer 30 preferably includes amorphous carbon and metal nanoparticles. The intermediate layer 30 may further include a binder, which serves as a binding material to maintain the structure.

Unlike graphite, for example, amorphous carbon is less likely to react with metals, such as lithium, to form alloys, and thus less likely to form dendrites, which contributes to the production of solid-state secondary batteries with improved cycle characteristics. Amorphous carbon may be easily graphitizable carbon (soft carbon) or hardly graphitizable carbon (hard carbon). Among carbon allotropes, amorphous carbon may be any carbon material not exhibiting any clear crystalline state or may be an aggregate of graphite microcrystals. Examples of amorphous carbon include carbon blacks, such as acetylene black, furnace black, and ketjen black, coke, activated carbon, CNT (carbon nanotubes), fullerenes, and graphene.

Examples of metal nanoparticles include nanoparticles of tin (Sn), silicon (Si), zinc (Zn), magnesium (Mg), gold (Au), platinum (Pt), palladium (Pd), silver (Ag), aluminum (Al), bismuth (Bi), antimony (Sb), and any other metal. The content of metal nanoparticles in the intermediate layer 30 is preferably more than 0 mass % and 30 mass % or less. In such a case, the intermediate layer 30 containing metal nanoparticles can have enhanced electron conductivity and allow the formation of a more uniform metal deposit layer. Metal nanoparticles, which have a Young's modulus higher than that of amorphous carbon, provides the intermediate layer 30 with the ability to maintain its structure even during high-pressure pressing in the solid-state secondary battery 100 manufacturing process.

The particles of amorphous carbon and the metal nanoparticles preferably have particle sizes smaller than those of the solid electrolyte material. In such a case, the intermediate layer 30 can enter into spaces between particles of the solid electrolyte material at the interface of the solid electrolyte layer 20 and thus increase the contact area and bonding strength between the solid electrolyte layer 20 and intermediate layer 30. The particle size of the amorphous carbon may be, for example, in the range of 0.04 to 0.05 μm in terms of median diameter (D50). The particle size of the metal nanoparticles may be, for example, approximately 0.07 μm in terms of median diameter (D50).

The binder is preferably capable of increasing the bonding strength between the particles in the intermediate layer 30 and between the intermediate layer 30 and the solid electrolyte layer 20. The binder may be any suitable type, such as that commonly used for solid-state secondary batteries. Examples of the binder include acrylic acid polymers, cellulose polymers, styrene polymers, vinyl acetate polymers, urethane polymers, and PVDF polymers, such as fluoroethylene polymers.

The negative electrode current collector 41 may be made of any material with any shape as long as it functions to collect electricity in the negative electrode layer 40. The negative electrode current collector 41 may be made of, for example, nickel, copper, or stainless steel. The negative electrode current collector 41 may be, for example, in a foil shape or a sheet or plate shape.

The metal layer 42 may be made of any material with any shape as long as it functions to allow dense deposition of charge carriers, such as lithium ions. In a case where the charge carriers are lithium ions, the metal layer 42 may be a metallic lithium layer or a layer of a metal capable of forming an alloy with lithium. Examples of the metal capable of forming an alloy with lithium include Mg, Si, Au, Ag, In, Ge, Sn, Pb, Al, and Zn. The metal used to form the metal layer 42 may be in the form of a powder or a thin film. In the negative electrode layer 40 including the metal layer 42 with such a feature, a uniform metal deposit layer can be formed on the surface of the metal layer 42. However, the metal layer 42 may be omitted.

The negative electrode lead wire 45 may be made of the same material as the negative electrode current collector 41 or may be made of a material different from that of the negative electrode current collector 41. The negative electrode lead wire 45 may be integrally connected to the negative electrode current collector 41. In an embodiment, the negative electrode lead wire 45 is formed as an extension of the negative electrode current collector 41 and integrally connected to the negative electrode current collector 41. The negative electrode terminal 46 may be made of the same material as the negative electrode lead wire 45 or may be made of a material different from that of the negative electrode lead wire 45. The negative electrode terminal 46 may be integrally connected to the negative electrode lead wire 45. In an embodiment, the negative electrode terminal 46 and the negative electrode lead wire 45 are different members electrically connected to each other.

The outer case 50 can expand and contract as the negative electrode changes its thickness during charging and discharging. The outer case 50 may be made of a laminated film. The laminated film may a multilayer film with a three-layer structure including an inner resin layer, a metal layer, and an outer layer in order from inside to outside. The outer resin layer may be, for example, a polyamide (nylon) layer or a polyethylene terephthalate (PET) layer. The metal layer may be, for example, an aluminum layer. The inner resin layer may be, for example, a polyethylene layer or a polypropylene layer.

In the solid-state secondary battery 100, the negative electrode layer 40, the intermediate layer 30, the solid electrolyte layer 20, and the positive electrode layer 10 may have Young's moduli in the order: the Young's modulus of the intermediate layer 30<the Young's modulus of the negative electrode layer 40<the Young's modulus of the solid electrolyte layer 20<the Young's modulus of the positive electrode layer 10. The Young's modulus of each layer depends on the material, porosity, and other properties of each layer. For example, the Young's modulus of the positive electrode layer 10 may be in the range of 190 to 200 GPa when the positive electrode active material is LiCoO₂ and may be 198 GPa when the positive electrode active material is NCM523. The Young's modulus of the solid electrolyte layer 20 may be in the range of 80 to 170 GPa when the solid electrolyte is an oxide and may be in the range of 18 to 22 GPa when the solid electrolyte is a sulfide. The Young's modulus of the negative electrode layer 40 may be in the range of 6 to 8 GPa when the negative electrode current collector 41 is copper and the metal layer 42 is lithium (it may be in the range of 4 to 5 GPa when the metal layer 42 is elemental lithium). The Young's modulus of the intermediate layer 30 may be 1 GPa or less or in the range of approximately 700 to 800 MPa.

### <Method for Manufacturing Solid-State Secondary Battery>

### First Embodiment

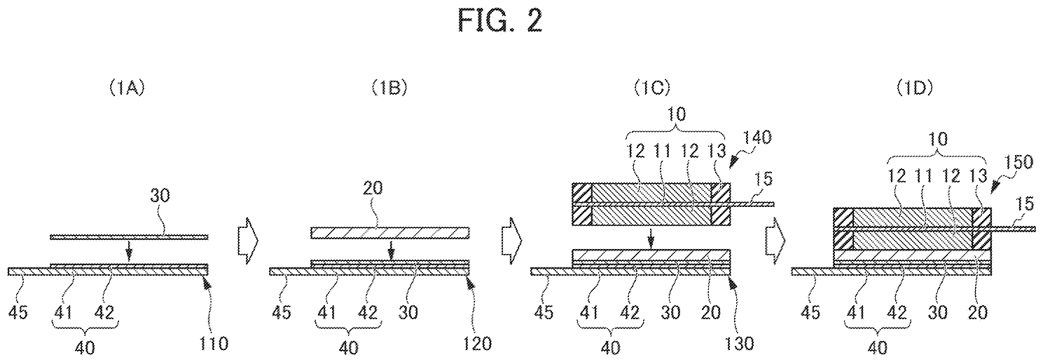

An embodiment of the present invention is directed to a method for manufacturing a solid-state secondary battery, including steps 1A, 1B, 1C, and 1D. FIG. 2 is a flow chart showing a solid-state secondary battery manufacturing method according to a first embodiment of the present invention.

The step 1A includes, as shown in Part 1A of FIG. 2, pressure-bonding an intermediate layer 30 and a negative electrode layer 40 of a lead wire-equipped negative electrode layer 110 to form a stack 120 of the intermediate layer and the negative electrode layer. In an embodiment, the lead wire-equipped negative electrode layer 110 is used as a source of the negative electrode layer 40. The lead wire-equipped negative electrode layer 110 includes the negative electrode layer 40 and a negative electrode lead wire 45 connected to a negative electrode current collector 41 in the negative electrode layer 40. The negative electrode layer 40 includes a negative electrode current collector 41 and a metal layer 42 provided on the surface of the negative electrode current collector 41. In an embodiment, the intermediate layer 30 is placed on the metal layer 42 of the lead wire-equipped negative electrode layer 110, and the resulting stack is subjected to pressure-bonding to form the stack 120 of the intermediate layer and the negative electrode layer. In the step 1A, the pressure-bonding may be performed at any suitable bonding pressure that allows for bonding without excessive deformation of each of the negative electrode layer 40 and the intermediate layer 30 and without producing a cause of delamination in the later steps. In the step 1A, the pressure-bonding is performed at a bonding pressure, for example, in the range of 300 to 500 MPa.

The step 1B includes, as shown in Part 1B of FIG. 2, pressure-bonding a solid electrolyte layer 20 and the intermediate layer 30 of the stack 120 to form a stack 130 of the negative electrode layer, the intermediate layer, and the solid electrolyte layer. A solid electrolyte layer transfer sheet may be used to form the solid electrolyte layer 20. The solid electrolyte layer transfer sheet is a multilayer sheet including: a support sheet; and a solid electrolyte layer 20 detachably provided on the surface of the support sheet. The step using the solid electrolyte layer transfer sheet may include placing the solid electrolyte layer 20 of the solid electrolyte layer transfer sheet on the intermediate layer 30 of the stack 120; subjecting the resulting stack to pressure-bonding to transfer the solid electrolyte layer 20 onto the intermediate layer 30 of the stack 120; and then peeling and removing the support sheet, so that the stack 130 of the negative electrode layer, the intermediate layer, and the solid electrolyte layer is obtained. In the step 1B, the pressure-bonding may be performed at any suitable bonding pressure that allows for bonding without excessive deformation of each of the negative electrode layer 40, the intermediate layer 30, and the solid electrolyte layer 20 and without producing a cause of delamination in the later steps. In an embodiment, therefore, the pressure-bonding in the step 1B is performed at a bonding pressure lower than that for the pressure-bonding in the step 1A. The bonding pressure for the pressure-bonding in the step 1B may be, for example, in the range of 1/10 to ½ of the bonding pressure for the pressure-bonding in the step 1A. The bonding pressure for the pressure-bonding in the step 1B is, for example, in the range of 50 to 100 MPa.

The step 1C includes, as shown in Part 1C of FIG. 2, pressure-bonding a positive electrode layer 10 and the solid electrolyte layer 20 of the stack 130 to form a multilayer electrode structure 150 (a stack of the positive electrode layer, the solid electrolyte layer, the intermediate layer, and the negative electrode layer). In an embodiment, a lead wire-equipped positive electrode layer 140 is used as a source of the positive electrode layer 10. The lead wire-equipped positive electrode layer 140 includes the positive electrode layer 10 and a positive electrode lead wire 15 connected to a positive electrode current collector 11 in the positive electrode layer 10. The positive electrode layer 10 includes the positive electrode current collector 11, positive electrode active material layers 12 provided on both sides of the positive electrode current collector 11, and insulating frames 13 surrounding the outer circumference of the positive electrode active material layers 12. In an embodiment, the positive electrode active material layer 12 of the lead wire-equipped positive electrode layer 140 is placed on the solid electrolyte layer 20 of the stack 130, and the resulting stack is subjected to pressure-bonding. This step produces a multilayer electrode structure 150 including the negative electrode layer 40, the intermediate layer 30, the solid electrolyte layer 20, and the positive electrode layer 10 stacked in order (see Part 1D of FIG. 2). A solid electrolyte layer 20, an intermediate layer 30, and a negative electrode layer 40 may be further stacked on the upper positive electrode active material layer 12 of the multilayer electrode structure 150. In the step 1C, the pressure-bonding is preferably performed at a bonding pressure that allows for bonding without excessive deformation of each of the negative electrode layer 40, the intermediate layer 30, the solid electrolyte layer 20, and the positive electrode layer 10 and without producing a cause of delamination during use of the battery. In an embodiment, therefore, the pressure-bonding in the step 1C is performed at a bonding pressure higher than that for the pressure-bonding in the step 1A. The bonding pressure for the pressure-bonding in the step 1C may be, for example, in the range of 1.5 to 3.0 times that for the pressure-bonding in the step 1A. The bonding pressure for the pressure-bonding in the step 1C is, for example, in the range of 500 to 800 MPa.

The step 1D includes, as shown in Part 1D of FIG. 2, applying a pressure to the multilayer electrode structure 150 in the direction in which the layers are stacked. In the step 1D, the pressure-bonding is preferably performed at a bonding pressure that can increase the density of the multilayer electrode structure 150 without causing excessive deformation of each of the negative electrode layer 40, the intermediate layer 30, the solid electrolyte layer 20, and the positive electrode layer 10. In an embodiment, therefore, the pressure-bonding in the step 1D is performed at a bonding pressure higher than that for the pressure-bonding in the step 1C. The bonding pressure for the pressure-bonding in the step 1D may be, for example, 1.05 times or more or in the range of 1.10 to 2.00 times that for the pressure-bonding in the step 1C. The bonding pressure for the pressure-bonding in the step 1D may be, for example, more than 800 MPa or may be in the range of 850 to 1,500 MPa.

The steps 1A to 1D may be performed using any suitable pressure-bonding machine, such as a roll press machine or a flat press machine. In the steps 1A to 1D, the pressure-bonding may be performed using a roll press machine. In such a case, the materials to be pressure-bonded may be fed in the same direction or different directions among the steps 1A to 1C. Among the steps 1C and 1D, the materials to be pressure-bonded are preferably fed to the roll press machine in different directions. Specifically, the direction in which the stack of the negative electrode layer, the intermediate layer, and the solid electrolyte layer is fed to the roll press machine in the step 1C is preferably different from the direction in which the multilayer electrode structure 150 is fed to the roll press machine in the step 1D. For example, the step 1C may include pressure-bonding the lead wire-equipped positive electrode layer 140 and the stack 130 of the negative electrode layer, the intermediate layer, and the solid electrolyte layer in a roll press machine to form the multilayer electrode structure 150, and the step 1D may include applying a pressure to the multilayer electrode structure 150 in a roll press machine. In such a case, the direction in which the multilayer electrode structure 150 is fed to the roll press machine in the step 1D may be perpendicular to the direction in which the stack 130 of the negative electrode layer, the intermediate layer, and the solid electrolyte layer is fed to the roll press machine in the step 1C. In such a case, the metal layer 42 and the intermediate layer 30 in the stack 130 of the negative electrode layer, the intermediate layer, and the solid electrolyte layer are pressurized and stretched in a first direction in the step 1C, and the metal layer 42 and the intermediate layer 30 in the multilayer electrode structure 150 are pressurized and stretched in a second direction in the step 1D, in which the first direction is perpendicular to the second direction. In such a case, the solid electrolyte layer 20 is less likely to suffer from defects, which would otherwise be caused by stretching the low Young's modulus layer, such as the metal layer 42 or the intermediate layer 30, only in a single direction so that the solid electrolyte layer 20 can also be stretched during the process.

The solid-state secondary battery 100 may be manufactured as described below using the multilayer electrode structure 150 obtained as described above. A positive electrode terminal 16 is connected to the positive electrode lead wire 15 of the multilayer electrode structure 150, and a negative electrode terminal 46 is connected to the negative electrode lead wire 45. Next, the multilayer electrode structure 150 with the positive and negative electrode terminals 16 and 46 connected thereto is placed in the outer case 50, which is then sealed.

In the solid-state secondary battery manufacturing method of the first embodiment including the steps described above, the solid electrolyte layer 20 is less likely to suffer from defects, such as breaking and cracking, in the step 1B because the bonding pressure for the pressure-bonding in the step 1B is lower than that for the pressure-bonding in the step 1A. Moreover, the solid electrolyte layer 20 is also less likely to suffer from defects even during the pressure-bonding in the step 1C, which is performed at a bonding pressure higher than that for the pressure-bonding in the step 1A, because the solid electrolyte layer 20 is supported by the intermediate layer 30 and the negative electrode layer 40 in the step 1C. Furthermore, the step 1D includes applying a pressure, higher than that for the pressure-bonding in the step 1C, to the multilayer electrode structure 150 in the direction in which the layers are stacked in the multilayer electrode structure 150. By such pressure application in the step 1D, the multilayer electrode structure 150 is densified and increased in the bonding strength between the layers. Thus, the solid-state secondary battery manufacturing method of the first embodiment can provide a solid-state secondary battery having a solid electrolyte layer 20 resistant to breaking, cracking, or other defects, having reduced inner resistance, and having improved characteristics, such as improved cycle characteristics.

### Second Embodiment

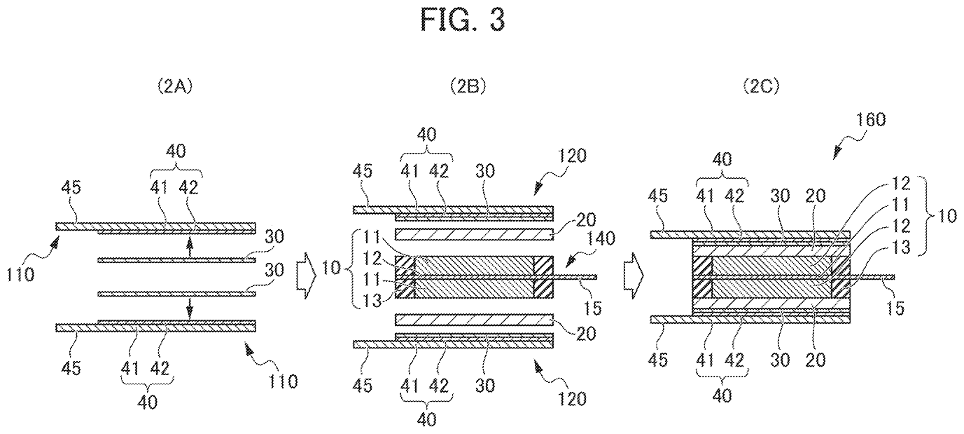

An embodiment of the present invention is directed to a method for manufacturing a solid-state secondary battery, including steps 2A, 2B, and 2C. FIG. 3 is a flow chart showing a solid-state secondary battery manufacturing method according to a second embodiment of the present invention. The solid-state secondary battery manufacturing method of the second embodiment may be performed using the same materials as those used in the method of the first embodiment. In FIG. 3, therefore, the same materials are represented by the same symbols as in FIG. 2, and the detailed description thereof will not be repeated below.

The step 2A includes, as shown in Part 2A of FIG. 3, pressure-bonding intermediate layers 30 and negative electrode layers 40 of lead wire-equipped negative electrode layers 110 to form a stack 120 of the intermediate layers and the negative electrode layers. In an embodiment, the lead wire-equipped negative electrode layer 110 is used as a source of the negative electrode layer 40, and the intermediate layers 30 are pressure-bonded to the negative electrode layers 40 of the lead wire-equipped negative electrode layers 110 to form a pair of stacks 120 of the intermediate layer and the negative electrode layer. In the step 2A, the pressure-bonding may be performed under any suitable conditions (including any suitable bonding pressure) that will not cause excessive deformation of each of the negative electrode layer 40 and the intermediate layer 30 and will not produce a cause of delamination in the later steps. In the step 2A, the pressure-bonding is performed at a bonding pressure, for example, in the range of 300 to 500 MPa.

The step 2B includes, as shown in Part 2B of FIG. 3, placing a solid electrolyte layer 20 and a positive electrode layer 10 in order on each of the intermediate layers 30 of the stacks 120; and pressure-bonding them to form a multilayer electrode structure 160. In an embodiment, a lead wire-equipped positive electrode layer 140 is used as a source of the positive electrode layer 10. The solid electrolyte layer 20 may include an internal porous substrate. The solid electrolyte layer including an internal porous substrate has a high strength and is resistant to deformation during pressure-bonding in the step 2B. In an embodiment, a pair of stacks 120 are arranged such that the intermediate layers 30 face each other; the solid electrolyte layers 20 are placed on the intermediate layers 30 of the pair of stacks 120, respectively; the lead wire-equipped positive electrode layer 140 is placed such that its positive electrode active material layers 12 are disposed between and opposed to the solid electrolyte layers 20; and the resulting stack is subjected to pressure-bonding. The resulting stack is a multilayer electrode structure 160 including the negative electrode layer 40, the intermediate layer 30, the solid electrolyte layer 20, the positive electrode layer 10, the solid electrolyte layer 20, the intermediate layer 30, and the negative electrode layer 40 stacked in order (see Part 2C of FIG. 3). In the step 2B, the pressure-bonding is preferably performed at a bonding pressure that allows for bonding without excessive deformation of each of the negative electrode layer 40, the intermediate layer 30, the solid electrolyte layer 20, and the positive electrode layer 10 and without producing a cause of delamination during use of the battery. In an embodiment, therefore, the pressure-bonding in the step 2B is performed at a bonding pressure higher than that for the pressure-bonding in the step 2A. The bonding pressure for the pressure-bonding in the step 2B may be, for example, in the range of 1.5 to 3.0 times that for the pressure-bonding in the step 2A. The bonding pressure for the pressure-bonding in the step 2B may be, for example, in the range of 500 to 800 MPa.

The step 2C includes, as shown in Part 1C of FIG. 2, applying a pressure to the multilayer electrode structure 160 in the direction in which the layers are stacked. In the step 2C, the pressure-bonding is preferably performed at a bonding pressure that will not excessively deform each of the negative electrode layer 40, the intermediate layer 30, the solid electrolyte layer 20, and the positive electrode layer 10 and will increase the density of the multilayer electrode structure 160. In an embodiment, therefore, the pressure-bonding in the step 2C is performed at a bonding pressure higher than that for the pressure-bonding in the step 2B. The bonding pressure for the pressure-bonding in the step 2C may be, for example, 1.05 times or more or in the range of 1.10 to 2.00 times that for the pressure-bonding in the step 2B. The bonding pressure for the pressure-bonding in the step 1C may be, for example, more than 800 MPa or in the range of 850 to 1500 MPa.

The steps 2A to 2C may be performed using any suitable pressure-bonding machine, such as a roll press machine or a flat press machine. In the steps 2A to 2C, the pressure-bonding may be performed using a roll press machine. In such a case, the materials to be pressure-bonded may be fed in the same direction or different directions among the steps 2A and 2B. Among the steps 2B and 2C, the materials to be pressure-bonded are preferably fed to the roll press machine in different directions. Specifically, the direction in which the stack 120 of the intermediate layer and the negative electrode layer is fed to the roll press machine in the step 2B is preferably different from the direction in which the multilayer electrode structure 160 is fed to the roll press machine in the step 2C. For example, the step 2B may include pressure-bonding the lead wire-equipped positive electrode layer 140, the solid electrolyte layer 20, and the stack 120 of the intermediate layer and the negative electrode layer in a roll press machine to form the multilayer electrode structure 160, and the step 2C may include applying a pressure to the multilayer electrode structure 160 in a roll press machine. In such a case, the direction in which the multilayer electrode structure 160 is fed to the roll press machine in the step 2C may be perpendicular to the direction in which the stack 120 of the intermediate layer and the negative electrode layer is fed to the roll press machine in the step 2B. In such a case, the metal layer 42 and the intermediate layer 30 in the stack 120 of the intermediate layer and the negative electrode layer are pressurized and stretched in a first direction in the step 2B, and the metal layer 42 and the intermediate layer 30 in the multilayer electrode structure 160 are pressurized and stretched in a second direction in the step 2C, in which the first direction is perpendicular to the second direction. In such a case, the solid electrolyte layer 20 is less likely to suffer from defects, which would otherwise be caused by stretching the low Young's modulus layer, such as the metal layer 42 or the intermediate layer 30, only in a single direction so that the solid electrolyte layer 20 can also be stretched during the process.

The solid-state secondary battery 100 may be manufactured as described below using the multilayer electrode structure 160 obtained as described above. A positive electrode terminal 16 is connected to the positive electrode lead wire 15 of the multilayer electrode structure 160, and a negative electrode terminal 46 is connected to the negative electrode lead wire 45. Next, the multilayer electrode structure 160 with the positive and negative electrode terminals 16 and 46 connected thereto is placed in the outer case 50, which is then sealed.

In the step 2B of the solid-state secondary battery manufacturing method of the second embodiment including the steps described above, the solid electrolyte layer 20 is less likely to suffer from defects even during the pressure-bonding at a bonding pressure higher than that for the pressure-bonding in the step 2A because it is supported by the intermediate layer 30 and the negative electrode layer 40. Moreover, in the step 2C, a pressure higher than that for the pressure-bonding in the step 2B is applied to the multilayer electrode structure 160 in the direction in which the layers are stacked. Such pressure application densifies the multilayer electrode structure 160 and increases the bonding strength between the layers in the multilayer electrode structure 160. Thus, the solid-state secondary battery resulting from the solid-state secondary battery manufacturing method of the second embodiment has a solid electrolyte layer 20 resistant to breaking, cracking, or any other defect and has reduced internal resistance and improved characteristics, such as improved cycle characteristics.

While some embodiments of the present invention have been described, it should be noted that such embodiments are not intended to limit the present invention. In the embodiments described above, the lead wire-equipped negative and positive electrode layers 110 and 140 are used as members for forming the negative and positive electrode layers 40 and 10, respectively. Alternatively, for example, lead wire-free members may be used to form the negative and positive electrode layers 40 and 10. For example, after the formation of the multilayer electrode structure, positive and negative electrode lead wires 15 and 45 may be connected to the positive and negative electrode current collectors 11 and 41, respectively.

In the embodiments described above, the negative electrode layer 40 includes the metal layer 42 and is configured to form a metal deposit layer on the surface of the metal layer 42 during charging. Alternatively, the negative electrode layer 40 may have any other configuration. The metal layer 42 may be replaced by a layer including a negative electrode active material capable of storing and releasing charge carriers, such as lithium ions. In such a case, the negative electrode active material layer may be disposed on the surface of the negative electrode current collector 41. The negative electrode active material may be one used for negative electrodes for common solid-state secondary batteries. In a case where the charge carriers are lithium ions, examples of the negative electrode active material include lithium transition metal oxides, such as lithium titanate, transition metal oxides, such as TiO₂, Nb₂O₃, and WO₃, Si, SiO, metal sulfides, metal nitrides, and carbon materials, such as artificial graphite, natural graphite, graphite, soft carbon, and hard carbon. The negative electrode active material layer may optionally contain a solid electrolyte for improving the charge carrier conductivity. The negative electrode active material layer may also optionally contain a conducting aid for improving the conductivity. The negative electrode active material layer may also optionally contain a binder for imparting flexibility. The solid electrolyte, the conducting aid, and the binder may be those commonly used for solid-state batteries.

### EXAMPLES

### Example 1

### [Preparation of Positive Electrode Layer]

An aluminum foil with a thickness of 15.0 μm was provided as a positive electrode current collector. A mixture was prepared of 80 parts by mass of lithium-nickel-cobalt-manganese composite oxide (NCM622) (positive electrode active material), 17 parts by mass of an argyrodite-type sulfide solid electrolyte (solid electrolyte), 2 parts by mass of carbon black (conducting aid), and 1 part by mass of SBR (styrene butadiene rubber) (binding material). The resulting mixture was dispersed in 43 parts by mass of butyl butyrate to form a slurry for a positive electrode active material layer. The resulting slurry was applied to one surface of the positive electrode current collector using a bar coater such that a coating with a dry weight of 27 mg/cm² could be formed. The coating was then dried to form an 80.0 μm-thick positive electrode active material layer, so that a positive electrode layer was obtained.

### [Preparation of Solid Electrolyte Layer Transfer Sheet]

A liquid dispersion of an argyrodite-type sulfide solid electrolyte (median diameter: 3.0 μm) was applied to a support sheet and then dried to form an argyrodite-type sulfide solid electrolyte layer, so that a solid electrolyte layer transfer sheet was obtained.

### [Preparation of Intermediate Layer Transfer Sheet]

A mixture was prepared of 95 parts by mass in total of Sn particles (metal nanoparticles with a median diameter of 0.07 μm) and acetylene black (amorphous carbon particles with a median diameter of 0.05 μm) and 5 parts by mass of a PVDF binder (binding material). The resulting mixture was dispersed in 1,000 parts by mass of NMP (N-methyl-2-pyrrolidone) to form a slurry for an intermediate layer. The resulting slurry was applied to a support sheet and then dried to form an intermediate layer (with a final thickness of 3.0 μm) transfer sheet.

### [Preparation of Negative Electrode Layer]

A 10 μm-thick copper foil was provided as a negative electrode current collector. A 40 μm-thick metallic lithium foil was placed on the surface of the copper foil to form a negative electrode layer.

### [Preparation of Multilayer Electrode Structure]

The intermediate layer was transferred from the intermediate layer transfer sheet onto the metallic lithium foil of the negative electrode layer. Subsequently, the negative electrode layer and the intermediate layer were pressure-bonded at a bonding pressure of 300 MPa to form a stack of the intermediate layer and the negative electrode layer (step I). Next, the solid electrolyte layer of the solid electrolyte layer transfer sheet was placed on the intermediate layer of the resulting stack, and then the intermediate layer and the solid electrolyte layer transfer sheet were pressure-bonded at a bonding pressure of 50 MPa. Subsequently, the support sheet was peeled off from the solid electrolyte layer transfer sheet, so that a stack of the negative electrode layer, the intermediate layer, and the solid electrolyte layer was obtained (step II). Next, the positive electrode active material layer of the positive electrode layer was placed on the solid electrolyte layer of the resulting stack, and then the solid electrolyte layer and the positive electrode layer were pressure-bonded at a bonding pressure of 500 MPa to form a multilayer electrode structure (a stack of the positive electrode layer, the solid electrolyte layer, the intermediate layer, and the negative electrode layer) (step III). Using a multi-stage press machine, a pressure of 980 MPa was applied to the resulting multilayer electrode structure in the direction in which the layers were stacked, so that the multilayer electrode structure was densified (step IV). The preparation of the multilayer electrode structure was completed as described above.

### [Preparation of Solid-State Secondary Battery]

A tab was attached to each of the positive and negative electrode current collectors of the resulting multilayer electrode structure. The multilayer electrode structure was then installed in a bag-shaped laminated pack. The laminated pack was then sealed under an argon atmosphere. A confining member was attached to the laminated pack from its top surface side in such a way that the member faced the negative electrode current collector of the multilayer electrode structure. As a result, a solid-state secondary battery with a confining pressure of 3 MPa applied to the multilayer electrode structure was obtained.

### Example 2

A solid-state secondary battery was prepared in the same way as in Example 1, except that the bonding pressure in step III was 550 MPa.

### Example 3

A solid-state secondary battery was prepared in the same way as in Example 1, except that the bonding pressure in step III was 600 MPa.

### Example 4

The intermediate layer was transferred from the intermediate layer transfer sheet onto the metallic lithium foil of the negative electrode layer. The metallic lithium foil and the intermediate layer were then pressure-bonded at a bonding pressure of 400 MPa to form a stack of the intermediate layer and the negative electrode (step I). Next, the solid electrolyte layer was placed on the intermediate layer of the resulting stack, and then the positive electrode active material layer of the positive electrode layer was placed on the solid electrolyte layer. Subsequently, the intermediate layer, the solid electrolyte layer, and the positive electrode layer were pressure-bonded together at a bonding pressure of 500 MPa to form a multilayer electrode structure (a stack of the positive electrode layer, the solid electrolyte layer, the intermediate layer, and the negative electrode layer) (step II). Next, using a multi-stage press machine, a pressure of 900 MPa was applied to the resulting multilayer electrode structure in the direction in which the layers were stacked, so that the multilayer electrode structure was densified (step III). A solid-state secondary battery was prepared in the same way as in Example 1, except for the above process.

### Example 5

A solid-state secondary battery was prepared in the same way as in Example 4, except that the bonding pressures in steps I and III were 430 MPa and 950 MPa, respectively.

### Example 6

A solid-state secondary battery was prepared in the same way as in Example 1, except that the bonding pressure in step IV was 950 MPa.

### Example 7

A solid-state secondary battery was prepared in the same way as in Example 1, except that the bonding pressures in steps III and IV were 600 MPa and 950 MPa, respectively.

### Comparative Example 1

A solid-state secondary battery was prepared in the same way as in Example 1, except that the multilayer electrode structure was prepared as described below. The solid electrolyte layer of the solid electrolyte layer transfer sheet was placed on the positive electrode active material layer of the positive electrode layer, and then the positive electrode layer and the solid electrolyte layer transfer sheet were pressure-bonded at a bonding pressure of 300 MPa. The support sheet was peeled off from the solid electrolyte layer transfer sheet, so that a stack of the positive electrode layer and the solid electrolyte layer was obtained (step I). Next, the intermediate layer was transferred from the intermediate layer transfer sheet onto the solid electrolyte layer of the resulting stack, and then the solid electrolyte layer and the intermediate layer were pressure-bonded at a bonding pressure of 500 MPa to form a stack of the positive electrode layer, the solid electrolyte layer, and the intermediate layer (step II). Next, using a multi-stage press machine, a pressure of 800 MPa was applied to the resulting stack in the direction in which the positive electrode layer, the solid electrolyte layer, and the intermediate layer were stacked (step III). The metallic lithium foil of the negative electrode layer was placed on the intermediate layer of the resulting densified stack, and then the solid electrolyte and the negative electrode layer were pressure-bonded at a bonding pressure of 300 MPa to form an multilayer electrode structure (a stack of the positive electrode layer, the solid electrolyte layer, the intermediate layer, and the negative electrode layer) (step IV).

### Comparative Example 2

A solid-state secondary battery was prepared in the same way as in Comparative Example 1, except that the bonding pressure in step III was 900 MPa.

### Comparative Example 3

A solid-state secondary battery was prepared in the same way as in Comparative Example 1, except that the bonding pressures in steps I, II, and IV were 80 MPa, 120 MPa, and 120 MPa, respectively.

### Comparative Example 4

A solid-state secondary battery was prepared in the same way as in Comparative Example 1, except that the bonding pressure in step IV was 120 MPa.

The process of preparing each of the multilayer electrode structures of Examples 1 to 7 and Comparative Examples 1 to 4 is shown in Tables 1A to 1D below.

### <Evaluation>

The negative electrode layers, the intermediate layers, the solid electrolyte layers, and the positive electrode layers for use in Examples 1 to 7 and Comparative Examples 1 to 4 were measured for Young's modulus. The intermediate layers and the solid electrolyte layers were also measured for porosity. The results are shown in Tables 2A.

The solid-state secondary batteries prepared in Examples 1 to 7 and Comparative Examples 1 to 4 were subjected to a cycle test including charge-discharge cycles with a charge upper limit voltage of 4.3 V, a discharge lower limit voltage of 2.65 V, and a C rate of 1/3 C. The first charge-discharge efficiency was calculated as the percentage of the first discharge capacity to the first charge capacity ((discharge capacity/charge capacity)×100). For the second and subsequent charge capacities, it was determined whether or not short circuit occurred in the solid-state secondary battery. A case where the percentage of the second discharge capacity to the first charge capacity ((second charge capacity/first discharge capacity)×100)) was more than 105% was evaluated as the “presence” of short circuit behavior during the second charging. A case where the percentage of the second discharge capacity to the first charge capacity was at most 105 was evaluated as the “absence” of short circuit behavior during the second charging. These results are shown in Table 2B.

TABLE 1A

| | Step I |
|---|---|
| Example 1 | Preparation of stack of intermediate layer and negative |
| | electrode layer |
| | (Bonding pressure: 300 MPa) |
| Example 2 | Preparation of stack of intermediate layer and negative |
| | electrode layer |
| | (Bonding pressure: 300 MPa) |
| Example 3 | Preparation of stack of intermediate layer and negative |
| | electrode layer |
| | (Bonding pressure: 300 MPa) |
| Example 4 | Preparation of stack of intermediate layer and negative |
| | electrode layer |
| | (Bonding pressure: 400 MPa) |
| Example 5 | Preparation of stack of intermediate layer and negative |
| | electrode layer |
| | (Bonding pressure: 430 MPa) |
| Example 6 | Preparation of stack of intermediate layer and negative |
| | electrode layer |
| | (Bonding pressure: 300 MPa) |
| Example 7 | Preparation of stack of intermediate layer and negative |
| | electrode layer |
| | (Bonding pressure: 300 MPa) |
| Comparative | Preparation of stack of positive electrode layer and solid |
| Example 1 | electrolyte layer |
| | (Bonding pressure: 300 MPa) |
| Comparative | Preparation of stack of positive electrode layer and solid |
| Example 2 | electrolyte layer |
| | (Bonding pressure: 300 MPa) |
| Comparative | Preparation of stack of positive electrode layer and solid |
| Example 3 | electrolyte layer |
| | (Bonding pressure: 80 MPa) |
| Comparative | Preparation of stack of positive electrode layer and solid |
| Example 4 | electrolyte layer |
| | (Bonding pressure: 300 MPa) |

TABLE 1B

| | Step II |
|---|---|
| Example 1 | Preparation of stack of negative electrode layer, |
| | intermediate layer, and solid electrolyte layer |
| | (Bonding pressure: 50 MPa) |
| Example 2 | Preparation of stack of negative electrode layer, |
| | intermediate layer, and solid electrolyte layer |
| | (Bonding pressure: 50 MPa) |
| Example 3 | Preparation of stack of negative electrode layer, |
| | intermediate layer, and solid electrolyte layer |
| | (Bonding pressure: 50 MPa) |
| Example 4 | Preparation of multilayer electrode structure (stack of |
| | positive electrode layer, solid electrolyte layer, |
| | intermediate layer, and negative electrode layer) |
| | (Bonding pressure: 500 MPa) |
| Example 5 | Preparation of multilayer electrode structure (stack of |
| | positive electrode layer, solid electrolyte layer, |
| | intermediate layer, and negative electrode layer) |
| | (Bonding pressure: 500 MPa) |
| Example 6 | Preparation of stack of negative electrode layer, |
| | intermediate layer, and solid electrolyte layer |
| | (Bonding pressure: 50 MPa) |
| Example 7 | Preparation of stack of positive electrode layer and solid |
| | electrolyte layer |
| | (Bonding pressure: 50 MPa) |
| Comparative | Preparation of stack of positive electrode layer, solid |
| Example 1 | electrolyte layer, and intermediate layer |
| | (Bonding pressure: 500 MPa) |
| Comparative | Preparation of stack of positive electrode layer, solid |
| Example 2 | electrolyte layer, and intermediate layer |
| | (Bonding pressure: 500 MPa) |
| Comparative | Preparation of stack of positive electrode layer, solid |
| Example 3 | electrolyte layer, and intermediate layer |
| | (Bonding pressure: 120 MPa) |
| Comparative | Preparation of stack of positive electrode layer, solid |
| Example 4 | electrolyte layer, and intermediate layer |
| | (Bonding pressure: 500 MPa) |

TABLE 1C

| | Step III |
|---|---|
| Example 1 | Preparation of multilayer electrode structure (stack of |
| | positive electrode layer, solid electrolyte layer, intermediate |
| | layer, and negative electrode layer) |
| | (Bonding pressure: 500 MPa) |
| Example 2 | Preparation of multilayer electrode structure (stack of |
| | positive electrode layer, solid electrolyte layer, intermediate |
| | layer, and negative electrode layer) |
| | (Bonding pressure: 550 MPa) |
| Example 3 | Preparation of multilayer electrode structure (stack of |
| | positive electrode layer, solid electrolyte layer, intermediate |
| | layer, and negative electrode layer) |
| | (Bonding pressure: 600 MPa) |
| Example 4 | Densification of multilayer electrode structure |
| | (Pressure: 900 MPa) |
| Example 5 | Densification of multilayer electrode structure |
| | (Pressure: 950 MPa) |
| Example 6 | Preparation of multilayer electrode structure (stack of |
| | positive electrode layer, solid electrolyte layer, intermediate |
| | layer, and negative electrode layer) |
| | (Bonding pressure: 500 MPa) |
| Example 7 | Preparation of multilayer electrode structure (stack of |
| | positive electrode layer, solid electrolyte layer, intermediate |
| | layer, and negative electrode layer) |
| | (Pressure: 600 MPa) |
| Comparative | Densification of stack of positive electrode layer, solid |
| Example 1 | electrolyte layer, and intermediate layer |
| | (Pressure: 800 MPa) |
| Comparative | Densification of stack of positive electrode layer, solid |
| Example 2 | electrolyte layer, and intermediate layer |
| | (Pressure: 900 MPa) |
| Comparative | Densification of stack of positive electrode layer, solid |
| Example 3 | electrolyte layer, and intermediate layer |
| | (Pressure: 800 MPa) |
| Comparative | Densification of stack of positive electrode layer, solid |
| Example 4 | electrolyte layer, and intermediate layer |
| | (Pressure: 800 MPa) |

TABLE 1D

| | Step IV |
|---|---|
| Example 1 | Densification of multilayer electrode structure |
| | (Pressure: 980 MPa) |
| Example 2 | Densification of multilayer electrode structure |
| | (Pressure: 980 MPa) |
| Example 3 | Densification of multilayer electrode structure |
| | (Pressure: 980 MPa) |
| Example 4 | — |
| Example 5 | — |
| Example 6 | Densification of multilayer electrode structure |
| | (Pressure: 950 MPa) |
| Example 7 | Densification of multilayer electrode structure |
| | ( Pressure: 950 MPa) |
| Comparative | Preparation of multilayer electrode structure (stack of |
| Example 1 | positive electrode layer, solid electrolyte layer, intermediate |
| | layer, and negative electrode layer) |
| | (Bonding pressure: 300 MPa) |
| Comparative | Preparation of stack of positive electrode layer, solid |
| Example 2 | electrolyte layer, and intermediate layer |
| | (Bonding pressure: 300 MPa) |
| Comparative | Preparation of stack of positive electrode layer, solid |
| Example 3 | electrolyte layer, and intermediate layer |
| | (Bonding pressure: 120 MPa) |
| Comparative | Preparation of stack of positive electrode layer, solid |
| Example 4 | electrolyte layer, and intermediate layer |
| | (Bonding pressure: 120 MPa) |

TABLE 2A

| | Physical properties of each layer | | | | | |
|---|---|---|---|---|---|---|
| | Negative | | | Solid electrolyte | | Positive |
| | electrode layer | Intermediate layer | | layer | | electrode layer |
| | Young's | Young's | | Young's | | Young's |
| | modulus | modulus | Porosity | modulus | Porosity | modulus |
| | (GPa) | (GPa) | (%) | (GPa) | (%) | (GPa) |
| Example 1 | 6.0 | 0.7 | 42 | 19 | 5 | 130 |
| Example 2 | 6.0 | 0.6 | 42 | 19 | 5 | 130 |
| Example 3 | 6.0 | 0.4 | 41 | 19 | 5 | 130 |
| Example 4 | 8.0 | 0.7 | 43 | 19 | 8 | 130 |
| Example 5 | 8.0 | 0.7 | 43 | 18 | 6 | 130 |
| Example 6 | 6.0 | 0.7 | 43 | 19 | 6 | 118 |
| Example 7 | 6.0 | 0.6 | 42 | 19 | 5 | 87 |
| Comparative | 6.0 | 0.7 | 44 | 19 | 8 | 130 |
| Example 1 | | | | | | |
| Comparative | 6.0 | 0.7 | 43 | 19 | 6 | 130 |
| Example 2 | | | | | | |
| Comparative | 6.0 | 0.7 | 44 | 19 | 8 | 130 |
| Example 3 | | | | | | |
| Comparative | 6.0 | 0.7 | 44 | 19 | 8 | 130 |
| Example 4 | | | | | | |

TABLE 2A

| | Battery characteristics | | |
|---|---|---|---|
| | | Presence or absence | Whether charging- |
| | | of short circuit | discharging at 25° |
| | First charge | behavior during | C. was possible (A) |
| | efficiency(%) | 2nd charging | or impossible (B) |
| Example 1 | 88.0 | Absent | A |
| Example 2 | 88.2 | Absent | A |
| Example 3 | 88.1 | Absent | A |
| Example 4 | 88.4 | Absent | A |
| Example 5 | 86.8 | Absent | A |
| Example 6 | 88.1 | Absent | A |
| Example 7 | 88.0 | Absent | A |
| Comparative | 73.0 | Present | B |
| Example 1 | | | |
| Comparative | 22.6 | Present | B |
| Example 2 | | | |
| Comparative | 60.0 | Present | B |
| Example 3 | | | |
| Comparative | 85.3 | Present | B |
| Example 4 | | | |

The results in Tables 1A to 1D and 2A to 2B indicate that the solid-state secondary batteries obtained in Examples 1 to 7 have high initial charge efficiency, are less likely to suffer from short circuit, and can be charged and discharged at 25° C. in spite of having a low Young's modulus intermediate layer between the negative electrode layer and the solid electrolyte layer. In contrast, the solid-state secondary batteries obtained in Comparative Examples 1, 2, 4, and 5, in which the negative electrode layer was bonded to a stack of the positive electrode layer, the solid electrolyte layer, and the intermediate layer, had low initial charge efficiency and suffered from short circuit at the second cycle, which made charging and discharging at 25° C. impossible. After the evaluation of the battery characteristics, the solid-state secondary batteries obtained in Comparative Examples 1 to 4 were disassembled and found to be broken or cracked in the solid electrolyte layer.

### EXPLANATION OF REFERENCE NUMERALS

1: Multilayer electrode structure
10: Positive electrode layer
11: Positive electrode current collector
12: Positive electrode active material layer
13: Insulating frame
20: Solid electrolyte layer
30: Intermediate layer
40: Negative electrode layer
41: Negative electrode current collector
42: Metal layer
50: Outer case
100: Solid-state secondary battery
110: Lead wire-equipped negative electrode layer
120: Stack of intermediate layer and negative electrode layer
130: Stack of solid electrolyte layer, intermediate layer, and negative electrode layer
140: Lead wire-equipped positive electrode layer
150, 160: Multilayer electrode structure

What is claimed is:

1. A method for manufacturing a solid-state secondary battery including a multilayer electrode structure including a negative electrode layer, an intermediate layer, a solid electrolyte layer, and a positive electrode layer stacked in order, the method comprising:
a step 1A comprising pressure-bonding a negative electrode layer and an intermediate layer to form a stack of the negative electrode layer and the intermediate layer;
a step 1B comprising pressure-bonding the intermediate layer of the stack and a solid electrolyte layer to form a stack of the negative electrode layer, the intermediate layer, and the solid electrolyte layer; and
a step 1C comprising pressure-bonding the solid electrolyte layer of the stack and a positive electrode layer to form the multilayer electrode structure,
wherein the pressure-bonding in the step 1B is performed at a bonding pressure lower than that for the pressure-bonding in the step 1A, and wherein the pressure-bonding in the step 1C is performed at a bonding pressure higher than that for the pressure-bonding in the step 1A.

2. The method according to claim 1, further comprising, after the step 1C, a step 1D comprising applying a pressure to the multilayer electrode structure in a direction in which the layers are stacked, wherein the pressure is higher than the bonding pressure for the pressure-bonding in the step 1C.

3. The method according to claim 1, wherein the negative electrode layer, the intermediate layer, the solid electrolyte layer, and the positive electrode layer have Young's moduli in the order: the Young's modulus of the intermediate layer<the Young's modulus of the negative electrode layer<the Young's modulus of the solid electrolyte layer<the Young's modulus of the positive electrode layer.

4. The method according to claim 1, wherein the pressure-bonding in the step 1A is performed at a bonding pressure in a range of 300 to 500 MPa, wherein the pressure-bonding in the step 1B is performed at a bonding pressure in a range of 50 to 100 MPa, and wherein the pressure-bonding in the step 1C is performed at a bonding pressure of 800 MPa or less.

5. The method according to claim 1, wherein the intermediate layer has a porosity greater than that of the solid electrolyte layer.

6. The method according to claim 2, wherein the pressure-bonding in the steps 1C and 1D is performed using a roll press machine, wherein the step 1C includes feeding the stack of the negative electrode layer, the intermediate layer, and the solid electrolyte layer in a first direction to the roll press machine, wherein the step 1D includes feeding the multilayer electrode structure in a second direction to the roll press machine, and wherein the first direction differs from the second direction.

7. A method for manufacturing a solid-state secondary battery including a multilayer electrode structure including a negative electrode layer, an intermediate layer, a solid electrolyte layer, and a positive electrode layer stacked in order, the method comprising:
a step 2A comprising pressure-bonding a negative electrode layer and an intermediate layer to form a stack of the negative electrode layer and the intermediate layer; and
a step 2B comprising placing a solid electrolyte layer and a positive electrode layer in order on the intermediate layer of the stack and pressure-bonding the intermediate layer of the stack, the solid electrolyte layer, and the positive electrode layer to form the multilayer electrode structure,
wherein the pressure-bonding in the step 2B is performed at a bonding pressure higher than that for the pressure-bonding in the step 2A.

8. The method according to claim 7, wherein the intermediate layer includes an inner porous substrate.

9. The method according to claim 7, further comprising, after the step 2B, a step 2C comprising applying a pressure to the multilayer electrode structure in a direction in which the layers are stacked, wherein the pressure is higher than the bonding pressure for the pressure-bonding in the step 2B.

10. The method according to claim 7, wherein the negative electrode layer, the intermediate layer, the solid electrolyte layer, and the positive electrode layer have Young's moduli in the order: the Young's modulus of the intermediate layer<the Young's modulus of the negative electrode layer<the Young's modulus of the solid electrolyte layer<the Young's modulus of the positive electrode layer.

11. The method according to claim 7, wherein the pressure-bonding in the step 2A is performed at a bonding pressure in a range of 300 to 500 MPa, and wherein the pressure-bonding in the step 2B is performed at a bonding pressure of 800 MPa or less.

12. The method according to claim 7, wherein the intermediate layer has a porosity greater than that of the solid electrolyte layer.

13. The method according to claim 9, wherein the pressure-bonding in the steps 2B and 2C is performed using a roll press machine, wherein the step 2B includes feeding the stack of the intermediate layer and the negative electrode layer in a first direction to the roll press machine, wherein the step 2C includes feeding the multilayer electrode structure in a second direction to the roll press machine, and wherein the first direction differs from the second direction.
